(19) United States
(12) Patent Application Publication
(10) Pub. No.: US 2008/0155197 A1
(43) Pub. Date: Jun. 26, 2008

(54) Locality optimization in multiprocessor systems

(76) Inventors: Wenlong Li, Beijing (CN); Haibo Lin, Beijing (CN)

Correspondence Address: RYDER IP LAW;C/O INTELLEVATE, LLC, P. O. BOX 52050, MINNEAPOLIS, MN, 55402, US

(21) Appl. No.: 11/711,936

(22) Filed: Feb. 28, 2007

(30) Foreign Application Priority Data
Dec. 22, 2006 (CN) PCT/CN06/03534

(51) Int. Cl. G06F 13/00

(52) U.S. Cl. 711/130

(57) ABSTRACT

In general, in one aspect, the disclosure describes a method to identify a set of tasks that share data and enqueue the set of tasks with a cluster identification, wherein the cluster identification indicates a cluster of processors that share cache.

### BACKGROUND

Symmetric multiprocessing (SMP) is a computer architecture that provides fast performance by making multiple CPUs available to complete individual processes simultaneously (multiprocessing). Any idle processor can be assigned any task, and additional CPUs can be added to improve performance and handle increased loads. A chip multiprocessor (CMP) includes multiple processor cores on a single chip, which allows more than one thread to be active at a time on the chip. A CMP is SMP implemented on a single integrated circuit. Thread-level parallelism (TLP) is the parallelism inherent in an application that runs multiple threads at once. A goal of SMP/CMP is to allow greater utilization of TLP.

FIG. 1 illustrates a block diagram of an example SMP system 100. The system 100 includes a plurality of CPUs 110 and a shared memory hierarchy 120. The memory hierarchy 120 may include a first level cache 130 associated with each CPU 110, a second level cache 140 (shared cache) associated with a group (e.g., four) of CPUs 110, and shared memory 150. The first level caches 130 may be connected to the shared caches 140 and the shared caches 140 may be connected the memory 150 via a bus or a ring. The CPUs 110 may be used to execute instructions that effectively perform the software routines that are executed by the computing system 100. The CPUs 110 may be used run multithreaded applications where different CPUs 110 are running different threads. The SMP system 100 may be implemented on a single integrated circuit (IC) in which each CPU 110 is a separate core on the IC (the SMP system 100 is a CMP).

Parallel programming languages (e.g., OpenMP, TBB, CILK) are used for writing multithreaded applications. The tasks to be performed in a multithreaded application may assign different tasks to different CPUs 110. Data that is used by multiple CPUs 110 is shared via the shared memory 150. Utilizing the shared memory 150 may result in long latency memory access and high bus bandwidth. It's the responsibility of the hardware to guarantee consistent memory access which may introduce performance overhead.

### BRIEF DESCRIPTION OF THE DRAWINGS

The features and advantages of the various embodiments will become apparent from the following detailed description in which:

FIG. 1 illustrates a block diagram of an example SMP system, according to one embodiment;

FIG. 2 illustrates an example application in which several tasks are being performed on the same data, according to one embodiment;

FIG. 3 illustrates an example parallel implementation of the application of FIG. 2 with program annotations, according to one embodiment;

FIG. 4 illustrates an example of a task list that may be utilized for a centralized scheduling scheme, according to one embodiment;

FIG. 5 illustrates example task lists that may be utilized for a distributed scheduling scheme, according to one embodiment; and

FIG. 6 illustrates a block diagram of an example SMP system utilizing prefetching, according to one embodiment.

### DETAILED DESCRIPTION

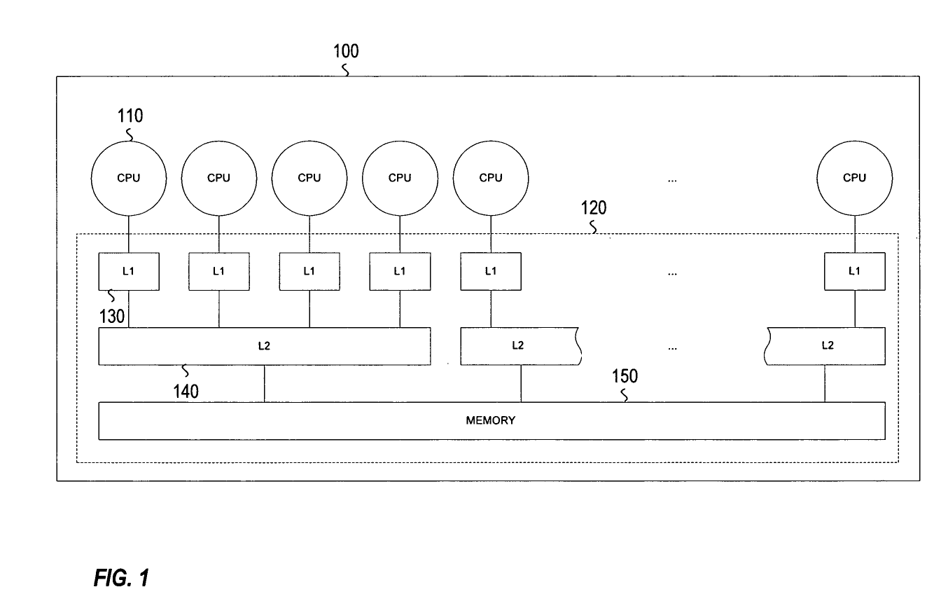

Referring back to FIG. 1, the cache 140 may be shared among a group of CPUs 110. Utilizing this shared cache 140 (locality) to assign local CPUs to threads that work on the same data may allow the data to be shared amongst the CPUs 110 in the shared cache 140 instead of the memory 150. Utilizing the cache 140 to share the data is beneficial because access to the cache 140 is faster than access to the memory 150 and does not require bus bandwidth to copy the data to memory 150. Accordingly, using the cache 140 reduces communication costs.

To exploit data locality in clustered SMP (e.g., 100), an application has to pass data sharing information to the architecture. The data sharing information may be passed either through a programmer's annotation by language extensions (annotations), or through compiler analysis on data flow. A parallel programming language (e.g., OpenMP, TBB, CILK) may be used to generate a multithreaded application.

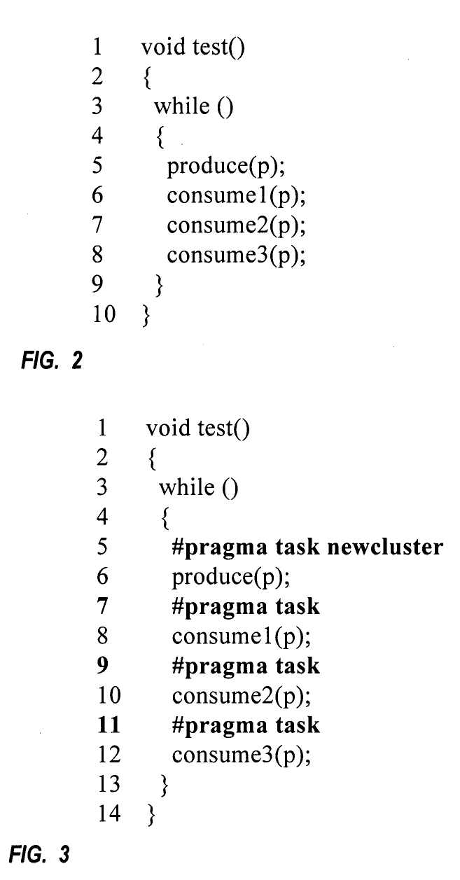

FIG. 2 illustrates an example application in which several tasks are being performed on the same data. In this case, a producer and 3 consumers share the same data p. It would be beneficial to have the four tasks assigned to a cluster of CPUs (e.g., 110) that share cache (e.g., 140). Utilizing the data locality of the shared cache may achieve fast communication between threads, whereas assigning the threads to different clusters of CPUs would require passing the data through long latency memory. The compiler could analyze the data flow of the application and determine that the first use of data p was the produce task (statement 5) and the last use was the third consume task (statement 8) and could utilize this determination at runtime to assign the tasks to a cluster of CPUs.

FIG. 3 illustrates an example parallel implementation (OpenMP) of the application of FIG. 2 with program annotations. Each of the tasks is identified with a task pragma with the first task also including a newcluster annotation. The newcluster annotation indicating that the particular task (in this case the produce task) should be performed on a new cluster. The succeeding tasks (in this case the consume tasks) will be performed on the same cluster until the cluster is either full or an annotation is made to start a new cluster.

The tasks are queued according to the assigned cluster and scheduling of the tasks is based on assigned clusters. The scheduling may be done centrally for the entire SMP or may be done in a distributed fashion.

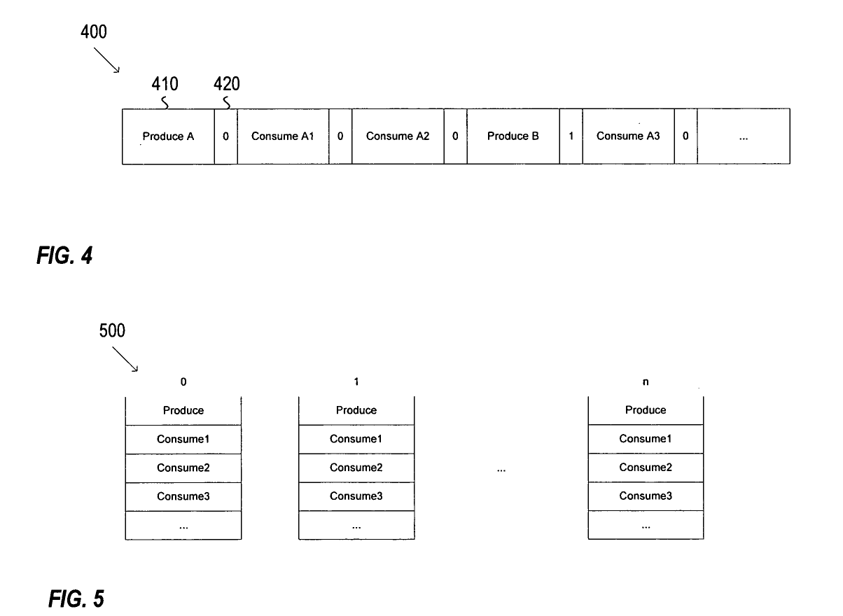

FIG. 4 illustrates an example of a task list 400 that may be utilized for a centralized scheduling scheme. The task list includes a global list of ready tasks 410 and each task is encoded with a cluster ID 420. When a newcluster annotation is received it will queue the task and assign the task a new cluster ID and those tasks that follow (e.g., the consumers that follow the producer) will also be queued and assigned the new cluster ID. As illustrated, the table 400 includes two producer tasks (A and B) and three consumer tasks (A1-A3). The producer A and the consumers A1-A3 are all assigned to cluster 0 and the producer B is assigned to cluster 1. It should be noted that the tasks may be entered in the table in the order they are undertaken which is not necessarily according to the cluster they are assigned to (e.g., producer B was queued prior to consumer A3 so it is recorded in the table first).

When a CPU is idle it may scan the task list 400 looking for a task having a cluster ID assigned to, or associated with, the CPU. In order to determine what CPU is assigned to what cluster a table may be used or the CPU ID may be divided by the number of CPUs in a cluster with the quotient being the cluster ID (e.g., if there are 16 CPUs numbered 0-15 and each cluster has 4 CPUs, CPUs 0-3 would be in cluster 1). If the CPU finds a task associated with its cluster it fetches the task from the list and executes it. If there are no tasks for the idle CPUs cluster, and task stealing is enabled, the CPU may pick any ready task from the task list and execute the task for load balancing purposes. According to one embodiment, preference may be given to tasks in close clusters (e.g., an idle CPU in cluster 0 would give preference to a task in cluster 1 over cluster 2) so that the data produced and consumed is as close as possible.

Because the centralized scheduling scheme employs a global list, the load can be distributed evenly across all CPUs. However, all tasks must be added to this global queue, the CPUs must scan this list looking for next tasks, and the tasks must be dequeued when finding a matching one. All of these accesses may introduce access contention overhead. Moreover, the global list would be to be stored in memory (e.g., 150) which would require bus bandwidth to access.

FIG. 5 illustrates example task lists 500 that may be utilized for a distributed scheduling scheme. Each cluster may have it's own task queue (each task queue may be bound to, associated with, a specific cluster). When a newcluster annotation is received the task will be enqueued in a next task queue associated with a new cluster and those tasks that follow (e.g., the consumers that follow the producer) will also be enqueued in that queue. As illustrated, each queue (0-n) has a producer and three consumers. However, the queues may have any number of tasks enqueued at a given time as the processing time for tasks vary (e.g., queue 0 may have 7 total tasks, queue 1 may have 4 total tasks, queue n may have 0 tasks) and each producer need not have three consumers associated therewith. When a CPU finishes with a task, it dequeues a next task from the associated queue. If the associated queue is empty, the CPU can steal a task from another queue. According to one embodiment, preference may be given to tasks in close clusters (e.g., an idle CPU in cluster 0 would give preference to a task in cluster 1 over cluster 2).

Because the disturbed queues are local to the cluster (e.g., stored in cache 140 of FIG. 1) enqueue and dequeue operations can be performed simultaneously, and therefore could be very fast in contrast to a centralized queue. However, as the queues are separate when a queue for any idle CPU is empty the CPU has to search other queues in order to find an available task for dequeuing and processing.

The determination of whether to utilize distributed or centralized scheduling may be based on the number of CPUs and clusters in the system. The more CPUs and clusters that there are the more overhead that may be necessary to have a centralized scheduler and the more beneficial it may be to implement a distributed scheduler. The determination may be made by the programmer. For example, the newcluster annotation may mean centralized while a newclusterd annotation may mean distributed.

FIGS. 4 and 5 above were discussed with respect to newcluster annotations being used to pass data sharing information that is used to assign the tasks to clusters. However, as mentioned above it is possible for the data sharing information to be passed through compiler analysis on data flow. The run-time library uses the data sharing information (whether provided by application annotations or data flow analysis) to assign the tasks to clusters.

Using the locality of the CPUs (e.g., 110) and the shared cache (e.g., 140) increases the efficiency and speed of a multithreaded application and reduces the bus traffic. The efficiency and speed may be further increased if data can be passed from the shared cache to local cache (e.g., 130) prior the CPU 110 needing the data. That is, the data for the cluster of CPUs is provided to local cache for each of the CPUs within the cluster. A mechanism such as data forwarding may be utilized on “consumer” CPUs to promote sharing of the data (e.g., produced by a producer CPU) from shared cache to higher level local cache. Data prefetching may also be used to prefetch the data from the shared cache to the local cache. In a system with multiple layers of local cache it is possible to prefetch or forward the data to the highest level (e.g., smallest size and fastest access time).

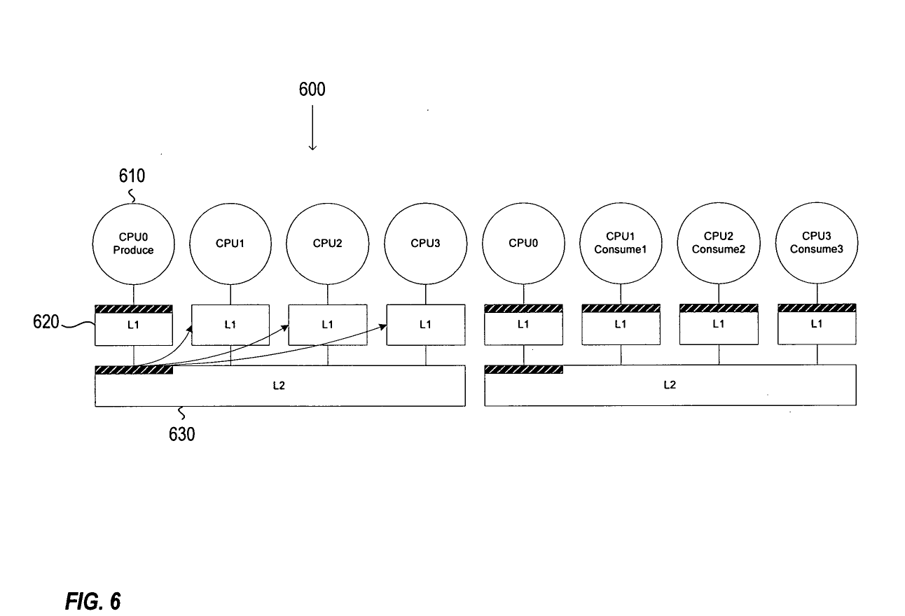

FIG. 6 illustrates a block diagram of an example SMP system 600. The system 600 includes a plurality of CPUs 610, local cache 620 associated with each CPU 610, and shared cache 620 associated with a group (e.g., four) of CPUs 610. As illustrated, there are a total of 8 CPUs 610 divided into two clusters of four. Each cluster has one producer CPU and three consumer CPUs and shared cache 630. Data may be written from CPU 0 (the producer) 610 through the local cache 620 to the shared cache 630. The consumer CPUs from the same cluster can snoop the interconnect (bus or ring) and fetch the data from the shared cache 630 into their local caches 620. The left side illustrates the local cache 620 snooping in the shared cache 630 while the right side illustrates the data in the local cache 620 prior to the consumer CPUs executing the tasks.

Various embodiments were described above with specific reference made to multithreaded applications with a single producer and multiple consumers. The various embodiments are in no way intended to be limited thereby. For example, a single producer could be associated with a single consumer or multiple producers could be associated with a single consumer or multiple consumers without departing from the scope. Moreover, parallel tasking could be implemented without departing from the scope. For example, the producer CPU could produce data in series and a plurality of consumers could process the results of the producer in parallel. The parallel tasking could be implemented using taskq and task pragmas where a producer produces data in series and the consumers execute tasks on the data in parallel.

Various embodiments were described above with specific reference made to the OpenMP parallel processing language. The various embodiments are in no way intended to be limited thereto but could be applied to any parallel programming language (e.g., CILK, TBB) without departing from the current scope. The compilers and libraries associated with any parallel programming language could be modified to incorporate clustering by locality.

The various embodiments were described with respect to multiprocessor systems with shared memory (e.g., SMP, CMP) but are not limited thereto. The various embodiments can be applied to any system having multiple parallel threads being executed and a shared memory amongst the threads without departing from the scope. For example, the various embodiments may apply to systems that have a plurality of microengines that perform parallel processing of threads.

Although the disclosure has been illustrated by reference to specific embodiments, it will be apparent that the disclosure is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

An embodiment may be implemented by hardware, software, firmware, microcode, or any combination thereof. When implemented in software, firmware, or microcode, the elements of an embodiment are the program code or code segments to perform the necessary tasks. The code may be the actual code that carries out the operations, or code that emulates or simulates the operations. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable or accessible medium” or “machine readable or accessible medium” may include any medium that can store, transmit, or transfer information. Examples of the processor/machine readable/accessible medium include an electronic circuit, a semiconductor memory device, a read only memory (ROM), a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The machine accessible medium may be embodied in an article of manufacture. The machine accessible medium may include data that, when accessed by a machine, cause the machine to perform the operations described in the following. The term “data” here refers to any type of information that is encoded for machine-readable purposes. Therefore, it may include program, code, data, file, etc.

All or part of an embodiment may be implemented by software. The software may have several modules coupled to one another. A software module is coupled to another module to receive variables, parameters, arguments, pointers, etc. and/or to generate or pass results, updated variables, pointers, etc. A software module may also be a software driver or interface to interact with the operating system running on the platform. A software module may also be a hardware driver to configure, set up, initialize, send and receive data to and from a hardware device.

An embodiment may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

The various embodiments are intended to be protected broadly within the spirit and scope of the appended claims.

What is claimed:

1. A method comprising
identifying a set of tasks that share data;
enqueuing the set of tasks with a cluster identification, wherein the cluster identification indicates a cluster of processors that share cache.

2. The method of claim 1, wherein said enqueuing includes enqueuing the tasks in a centralized queue.

3. The method of claim 1, wherein said enqueuing includes enqueuing the tasks in distributed queues.

4. The method of claim 3, wherein the distributed queues are associated with clusters of processors.

5. The method of claim 1, further comprising
determining a processor is available for processing;
finding a task associated with the cluster identification for the processor; and
dequeuing the task.

6. The method of claim 1, further comprising
determining a processor is available for processing;
determining no tasks are associated with the cluster identification for the processor; and
dequeuing a task associated with another cluster identification.

7. The method of claim 1, further comprising storing the shared data in the shared cache.

8. The method of claim 7, further comprising prefetching the shared data from the shared cache to cache associated with consumer processors within the cluster.

9. The method of claim 1, wherein said identifying includes indicating a new cluster with a specific annotation.

10. The method of claim 1, wherein said identifying includes analyzing data flow to identify shared data.

11. A machine-accessible medium comprising content, which, when executed by a machine causes the machine to:
identify tasks that share data;
enqueue the tasks with a cluster identification, wherein the cluster identification indicates a cluster of processors that share cache.

12. The machine-accessible medium of claim 11, wherein the content causing the machine to enqueue enqueues the tasks in a centralized queue.

13. The machine-accessible medium of claim 11, wherein the content causing the machine to enqueue enqueues the tasks in distributed queues, wherein the distributed queues are associated with clusters of processors.

14. The machine-accessible medium of claim 11, wherein when executed the content further causes the machine to
determine a processor is available for processing;
find a task associated with the cluster identification for the processor; and
dequeue the task.

15. The machine-accessible medium of claim 11, wherein when executed the content further causes the machine to
determine a processor is available for processing;
determine no tasks are associated with the cluster identification for the processor; and
dequeue a task associated with another cluster identification.

16. The machine-accessible medium of claim 11, wherein when executed the content further causes the machine to
store the shared data in the shared cache; and
prefetch the shared data from the shared cache to cache associated with consumer processors within the cluster.

17. A system comprising
an integrated circuit including a plurality of processors and cache shared between sets of processors; and
memory coupled to the integrated circuit to store a multithreaded application, the application when executed causing the integrated circuit to
identify tasks that share data;
enqueue the tasks with a cluster identification, wherein the cluster identification indicates a cluster of processors that share cache; and
stored the shared data in shared cache.

18. The system of claim 17, wherein the application when executed further causes the integrated circuit to
determine a processor is available for processing;
find a task associated with the cluster identification for the processor;
dequeue the task; and
execute the task.

19. The system of claim 17, wherein the application when executed further causes the integrated circuit to
determine a processor is available for processing;
determine no tasks are associated with the cluster identification for the processor;
dequeue a task associated with another cluster identification; and
execute the task.

20. The system of claim 17, wherein the integrated circuit further includes local cache associated with the processors and the processors prefetch the shared data from the shared cache to the local cache.
